(19) United States
(12) Patent Application Publication
(10) Pub. No.: US 2019/0193677 A1
(43) Pub. Date: Jun. 27, 2019

(54) DISTRIBUTION DEVICE, RESCUE SYSTEM, METHOD OF CONTROLLING DISTRIBUTION DEVICE, AND RECORDING MEDIUM

(71) Applicant: TOYOTA JIDOSHA KABUSHIKI KAISHA, Toyota-shi (JP)

(72) Inventors: Ryuichi SUZUKI, Nagakute-shi (JP); Yuki ITO, Iwakura-shi (JP); Hiroyasu SHIOKAWA, Nagoya-shi (JP); Yasumasa KOBAYASHI, Nagoya-shi (JP); Naoki YAMAMURO, Nagoya-shi (JP); Makoto AKAHANE, Nagoya-shi (JP)

(73) Assignee: TOYOTA JIDOSHA KABUSHIKI KAISHA, Toyota-shi (JP)

(21) Appl. No.: 16/175,999

(22) Filed: Oct. 31, 2018

(30) Foreign Application Priority Data
Dec. 27, 2017 (JP) 2017-251175

(51) Int. Cl. B60R 25/20; H04L 29/08; H04W 4/80; B60R 25/102; B60R 25/24

(52) U.S. Cl. CPC B60R 25/2018; H04L 67/18; H04W 4/80; B60R 2325/202; B60R 25/24; B60R 2325/103; B60R 2325/205; B60R 25/102

(57) ABSTRACT

A distribution device includes a server device configured to distribute key information to a portable terminal. The key information is used for a key system that determines whether or not to lock and unlock a vehicle when the vehicle receives the key information transmitted from the portable terminal to the vehicle. The server device is configured to receive a rescue signal and positional information of the vehicle transmitted from the vehicle in a case where a state in a vehicle cabin of the vehicle is a predetermined rescue needing state. The server device is configured to, when the server device receives the rescue signal, search for a nearby terminal based on the positional information of the vehicle, and transmit the key information of the vehicle, the positional information of the vehicle, and an issue command of an alarm signal to the portable terminal searched for as the nearby terminal.

### INCORPORATION BY REFERENCE

The disclosure of Japanese Patent Application No. 2017-251175 filed on Dec. 27, 2017 including the specification, drawings and abstract is incorporated herein by reference in its entirety.

### BACKGROUND

### 1. Technical Field

The present disclosure relates to a distribution device that distributes key information of a vehicle, a rescue system, a method of controlling a distribution device, and a non-transitory computer-readable recording medium storing a program causing a computer to execute a method of controlling a distribution device.

### 2. Description of Related Art

A system that makes a portable terminal such as a smartphone usable as a key of a vehicle has been developed. In such a system, by transmitting key information associated with the vehicle from the portable terminal to the vehicle, locking and unlocking of the vehicle is performed, and the vehicle is ready for driving.

Here, Japanese Unexamined Patent Application Publication No. 2015-169008 (JP 2015-169008 A) discloses a system that enables operation of a vehicle in a case where key authentication is established between an electronic key (smart key) and the vehicle when unique identification information of the electronic key, which is transmitted from the electronic key to the vehicle matches identification information of the vehicle and terminal authentication is established between the vehicle and the portable terminal on which pairing is being performed.

Japanese Unexamined Patent Application Publication No. 2001-229476 (JP 2001-229476 A) discloses a technology of issuing an alert signal and automatically opening a trunk of a vehicle in a case where it is detected that a certain living body is present in the trunk of the vehicle.

Japanese Unexamined Patent Application Publication No. 2000-289459 (JP 2000-289459 A) discloses a technology of notifying an outside of a vehicle of an abnormality and releasing a door lock of the vehicle in a case where a temperature in a vehicle cabin detected by a temperature sensor exceeds a specific temperature and a seat sensor detects that a person or an animal is present in the vehicle cabin.

### SUMMARY

It is difficult for a child or an animal to unlock a vehicle on their own and escape from the vehicle when the vehicle is locked in a state in which the child or the animal is left behind in the vehicle cabin. Under such circumstances, a deterioration of an environment in the vehicle cabin (for example, an excessive temperature rise) gives rise to accidents that cause the child or the animal left behind in the vehicle cabin to be in a poor health condition. Here, when another person around the vehicle can rescue the person or the animal left behind in the vehicle cabin, occurrence of such accidents can be suppressed.

The present disclosure provides a distribution device, a rescue system, a method of controlling a distribution device, and a non-transitory computer-readable recording medium storing a program causing a computer to execute a method of controlling a distribution device that enable a person or an animal left behind in a vehicle cabin to be rescued by another person around the vehicle.

A first aspect of the present disclosure relates to a distribution device. The distribution device includes a server device configured to distribute key information to a portable terminal. The key information is used for a key system that determines whether or not to lock and unlock a vehicle when the vehicle receives the key information transmitted from the portable terminal to the vehicle. The server device is configured to receive a rescue signal and positional information of the vehicle transmitted from the vehicle in a case where a state in a vehicle cabin of the vehicle is a predetermined rescue needing state in which a person or an animal present in the vehicle cabin needs to be rescued. The server device is configured to, when the server device receives the rescue signal, search for a nearby terminal which is a portable terminal present within a predetermined range from a position of the vehicle based on the positional information of the vehicle, and transmit the key information of the vehicle, the positional information of the vehicle, and an issue command of an alarm signal for prompting rescue of the person or the animal present in the vehicle cabin of the vehicle to the portable terminal searched for as the nearby terminal.

The distribution device according to the first aspect of the present disclosure includes the server device that distributes the key information related to the key system to the portable terminal. Here, the key system is a system in which the locking and unlocking of the vehicle is performed by transmitting key information associated with the vehicle from the portable terminal to the vehicle. In other words, when the portable terminal receives the key information distributed from the server device, a person carrying the portable terminal can lock and unlock a vehicle associated with the key information.

Then, the distribution device according to the first aspect of the present disclosure receives the positional information of the vehicle from the server device. The server device also receives the rescue signal transmitted from the vehicle in a case where the state in the vehicle cabin of the vehicle is the predetermined rescue needing state in which the person or the animal present in the vehicle cabin needs to be rescued. Here, the predetermined rescue needing state means a state on which a determination can be made that the person or the animal is present in the vehicle cabin and the environment in the vehicle cabin has become an environment in which there is a possibility of harming the person or the animal.

When the rescue signal is received by the server device, the nearby terminal is searched for based on the positional information of the vehicle. The nearby terminal means the portable terminal present within the predetermined range from the position of the vehicle. Here, the predetermined range is set as a range at which the person carrying the nearby terminal is considered to be able to go to rescue the person or the animal left behind in the vehicle cabin of the vehicle which is a transmission source of the rescue signal. When the nearby terminal is found by the server device, the positional information of the vehicle and the issue command are transmitted to the nearby terminal together with the key information of the vehicle. Here, the issue command is a command for issuing the alarm signal for prompting the rescue of the person or the animal present in the vehicle cabin from the nearby terminal to the person carrying the nearby terminal.

When the nearby terminal receives the positional information of the vehicle and the issue command from the server device, the positional information of the vehicle is notified from the nearby terminal, and the alarm signal is issued from the nearby terminal. Accordingly, it is possible to prompt the person carrying the nearby terminal to go to the vehicle that has transmitted the rescue signal for rescue. Further, when the nearby terminal receives the key information, the person carrying the nearby terminal can unlock the vehicle using the nearby terminal as a key to rescue the person or the animal left behind in the vehicle cabin. Therefore, another person around the vehicle can rescue the person or the animal left behind in the vehicle cabin.

In the distribution device according to the first aspect of the present disclosure, the server device may be configured to communicate with a terminal information management device that manages positional information of a plurality of portable terminals. The server device may be configured to search for the nearby terminal based on the positional information of the vehicle and the positional information of the portable terminals in the terminal information management device. In this way, by using the positional information of the portable terminals in the terminal information management device, it is possible to easily search for the nearby terminal.

In the distribution device according to the first aspect of the present disclosure, the server device may be configured to transmit vehicle information for specifying the vehicle, together with the key information of the vehicle, the positional information of the vehicle, and the issue command, to the nearby terminal. Here, as the vehicle information, a vehicle type field, a color field, or a number (a vehicle registration number) field can be exemplified. Such vehicle information may be stored in the distribution device in advance in association with the key information. By transmitting the vehicle information to the nearby terminal, it is possible for the person carrying the nearby terminal to more easily specify the vehicle which is the issue source of the rescue signal.

A second aspect of the present disclosure relates to a rescue system. The rescue system includes a portable terminal, a vehicle, and a server device. The vehicle is equipped with a key system configured to perform locking and unlocking by receiving key information transmitted from the portable terminal. The vehicle includes a detection device configured to detect whether or not a state in a vehicle cabin of the vehicle has become a predetermined rescue needing state in which a person or an animal present in the vehicle cabin needs to be rescued. The vehicle includes a signal transmitter configured to transmit positional information of the vehicle and transmit a rescue signal in a case where the detection device detects that the state in the vehicle cabin has become the predetermined rescue needing state. The server device is configured to receive the rescue signal and the positional information that are transmitted from the signal transmitter. The server device is configured to search for a nearby terminal which is a portable terminal present within a predetermined range from a position of the vehicle based on the positional information of the vehicle in a case where the rescue signal is received from the signal transmitter. The server device is configured to transmit the key information of the vehicle, the positional information of the vehicle, and an issue command of an alarm signal for prompting rescue of the person or the animal present in the vehicle cabin of the vehicle, to the portable terminal searched for as the nearby terminal. The portable terminal is configured to provide a notification of the positional information of the vehicle and to issue the alarm signal when the portable terminal searched for as the nearby terminal receives the key information of the vehicle, the positional information of the vehicle, and the issue command of the alarm signal that are transmitted from the server device.

In the rescue system according to the second aspect of the present disclosure, the detection device provided in the vehicle detects whether or not the state in the vehicle cabin of the vehicle has become the predetermined rescue needing state. The signal transmitter provided in the vehicle transmits the rescue signal to the server device together with the positional information of the vehicle. Then, the server device searches for the nearby terminal and transmits the key information of the vehicle, the positional information of the vehicle, and the issue command of the alarm signal to the portable terminal searched for as the nearby terminal. Furthermore, the portable terminal searched for as the nearby terminal provides the notification of the positional information of the vehicle and issues the alarm signal. Accordingly, it is possible to prompt the person carrying the portable terminal which has become the nearby terminal to go for rescue, and the person carrying the portable terminal can unlock the vehicle using the portable terminal.

In the rescue system according to the second aspect of the present disclosure, when the portable terminal searched for as the nearby terminal receives the key information of the vehicle, the positional information of the vehicle, and the issue command of the alarm signal that are transmitted from the server device, the portable terminal may provide the notification of the positional information of the vehicle, issue the alarm signal, and transmit the key information and an unlocking request to the vehicle according to a manipulation of a person carrying the portable terminal.

A third aspect of the present disclosure relates to a method of controlling a distribution device. The distribution device includes a server device configured to distribute key information to a portable terminal. The key information is used for a key system that determines whether or not to lock and unlock a vehicle when the vehicle receives the key information transmitted from the portable terminal to the vehicle. The method includes receiving a rescue signal and positional information of the vehicle transmitted from the vehicle when a state in a vehicle cabin of the vehicle becomes a predetermined rescue needing state in which a person or an animal present in the vehicle cabin needs to be rescued, using the server device, and searching for a nearby terminal which is a portable terminal present within a predetermined range from a position of the vehicle based on the positional information of the vehicle, and transmitting the key information of the vehicle, the positional information of the vehicle, and an issue command of an alarm signal for prompting rescue of the person or the animal present in the vehicle cabin of the vehicle to the nearby terminal, using the server device.

A fourth aspect of the present disclosure relates to a non-transitory computer-readable recording medium storing a program causing a computer to execute a method of controlling a distribution device. The distribution device includes a server device configured to distribute key information to a portable terminal. The key information is used for a key system that determines whether or not to lock and unlock a vehicle when the vehicle receives the key information transmitted from the portable terminal to the vehicle. The program causes a control process of the distribution device to be executed. The control process includes receiving a rescue signal and positional information of the vehicle transmitted from the vehicle when a state in a vehicle cabin of the vehicle becomes a predetermined rescue needing state in which a person or an animal present in the vehicle cabin needs to be rescued, using the server device, and searching for a nearby terminal which is a portable terminal present within a predetermined range from a position of the vehicle based on the positional information of the vehicle, and transmitting the key information of the vehicle, the positional information of the vehicle, and an issue command of an alarm signal for prompting rescue of the person or the animal present in the vehicle cabin of the vehicle to the nearby terminal, using the server device.

According to the aspects of the present disclosure, another person around the vehicle can rescue the person or the animal left behind in the vehicle cabin.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a diagram illustrating an outline of a key system according to an embodiment;

FIG. 2 is a block diagram schematically illustrating an example of a configuration of a portable terminal and a vehicle control device illustrated in FIG. 1;

FIG. 3 is a diagram illustrating processing and data flow when a door of a vehicle is unlocked;

FIG. 4 is a diagram for describing a network to which a rescue system according to the embodiment is connected;

FIG. 5 is a block diagram schematically illustrating an example of a configuration of a vehicle, a center server, a portable terminal, and a terminal management server illustrated in FIG. 4;

FIG. 6 is a flowchart illustrating flow of detection processing executed by a controller of a detection device;

FIG. 7 is a diagram illustrating an example a configuration of a vehicle management information table stored in a vehicle DB;

FIG. 8 is a diagram illustrating an example of a configuration of a terminal management information table stored in a terminal DB; and

FIG. 9 is a diagram illustrating processing and data flow in a case where a vehicle of which a state in a vehicle cabin has become a predetermined rescue needing state is unlocked using a nearby terminal, by using the rescue system according to the embodiment.

### DETAILED DESCRIPTION OF EMBODIMENTS

Hereinafter, specific embodiments of the present disclosure will be described with reference to the drawings. Dimensions, materials, shapes, relative dispositions, and the like of components described in the present embodiment are not intended to limit the technical scope of the present disclosure solely to those unless otherwise specified.

### Embodiment

### Outline of Key System

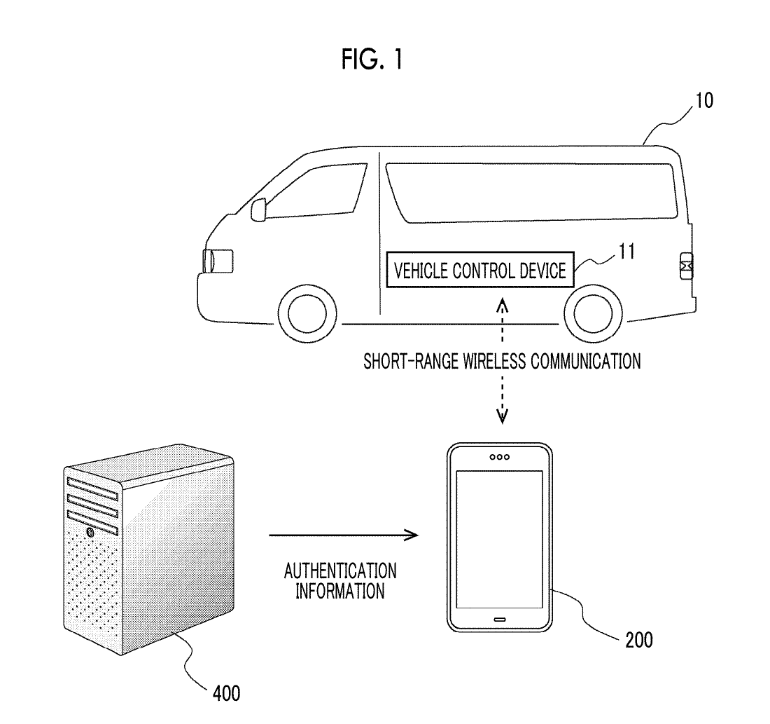

FIG. 1 is a diagram illustrating an outline of the key system according to an embodiment. The key system according to the embodiment is configured to include a vehicle control device 11 mounted on a vehicle 10, a portable terminal 200, and a center server 400. The portable terminal 200 and the center server 400 are connected to each other via a network such as the Internet which is a public communication network. Then, the portable terminal 200 and the vehicle control device 11 are connected to each other through short-range wireless communication.

The center server 400 is a device that manages authentication information associated with the vehicle 10 and distributes the authentication information. When the authentication information distributed from the center server 400 is received, the portable terminal 200 can be used as a key of the vehicle 10. When the portable terminal 200 is used as the key of the vehicle 10, the portable terminal 200 transmits the authentication information received from the center server 400 to the vehicle control device 11 mounted on the vehicle 10 through short-range wireless communication. The vehicle control device 11 authenticates the authentication information received from the portable terminal 200. When the authentication information is successfully authenticated, the vehicle control device 11 can execute various controls on the vehicle 10. In the embodiment, the authentication information is an example of “key information” according to the aspects of the present disclosure and the center server 400 is an example of “distribution device” according to the aspects of the present disclosure.

### System Configuration of Key System

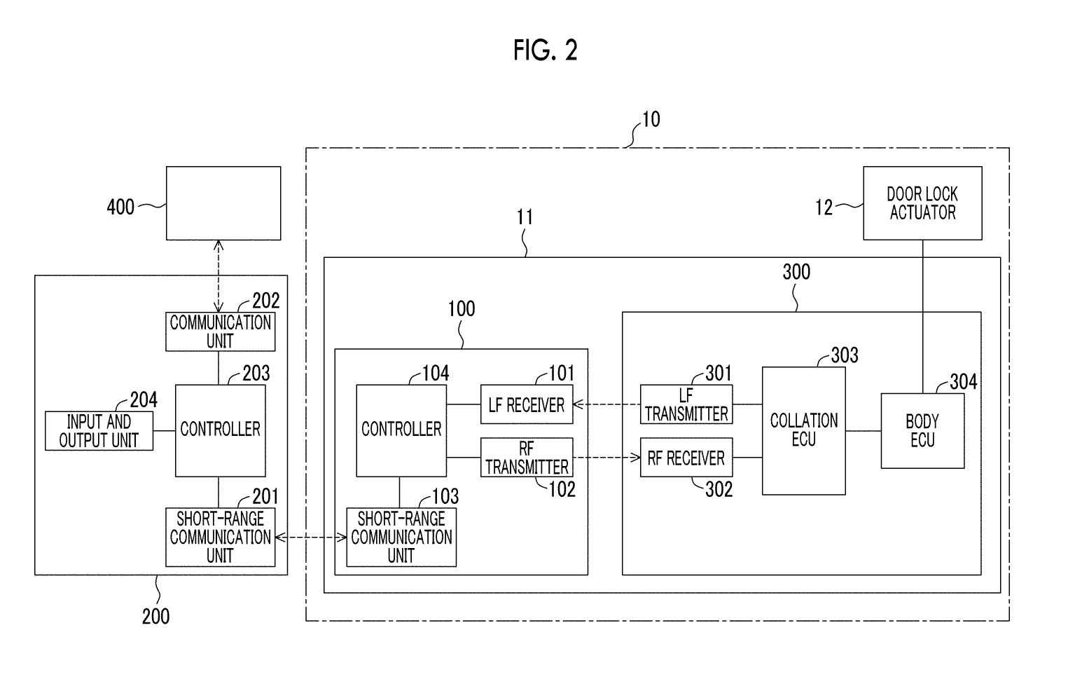

Each component in the key system according to the embodiment will be described with reference to FIG. 2. FIG. 2 is a block diagram schematically illustrating an example of the configuration of the portable terminal 200 and the vehicle control device 11 illustrated in FIG. 1. The vehicle control device 11 includes a key unit 100 that communicates with the portable terminal 200 and a control device 300 that executes various controls on the vehicle 10.

The control device 300 transmits and receives radio waves in a radio frequency (hereinafter referred to as RF) band and a low frequency (hereinafter referred to as LF) band with the key unit 100 in the vehicle 10 to execute the various controls. For example, the control device 300 executes a locking and unlocking control for locking and unlocking the vehicle 10 by controlling a door lock actuator 12 of the vehicle 10.

The control device 300 is configured to include an LF transmitter 301, an RF receiver 302, a collation electronic control unit (ECU) 303, and a body ECU 304. The LF transmitter 301 is a device that transmits radio waves in an LF band (for example, 100 KHz to 300 KHz) for checking (polling) the key unit 100. The RF receiver 302 is a device that receives radio waves in an RF band (for example, 100 MHz to 1 GHz) transmitted from the key unit 100.

The collation ECU 303 is a computer that controls the body ECU 304 based on a command signal transmitted from the key unit 100 via radio waves in the RF band. The collation ECU 303 is constituted by, for example, a microcomputer. The collation ECU 303 authenticates that the command signal transmitted from the key unit 100 is transmitted from an authorized device. Specifically, the collation ECU 303 determines whether or not a key ID included in the command signal matches a key ID stored in advance in a storage unit of the collation ECU 303.

When the collation ECU 303 successfully authenticates the key ID, the collation ECU 303 transmits a command according to the command signal to the body ECU 304 via an in-vehicle network such as a controller area network (CAN). Specifically, when the command signal received from the key unit 100 is a locking signal, the collation ECU 303 transmits a locking command for locking the vehicle 10 to the body ECU 304. When the command signal received from the key unit 100 is an unlocking signal, the collation ECU 303 transmits an unlocking command for unlocking the vehicle 10 to the body ECU 304.

The body ECU 304 is a computer that performs a body control of the vehicle 10. The body ECU 304 is electrically connected to the door lock actuator 12 that locks and unlocks the door of the vehicle 10. The body ECU 304 has a function of unlocking and locking the vehicle 10 by controlling the door lock actuator 12 based on the unlocking command or the locking command received from the collation ECU 303.

In addition to the body ECU 304, the control device 300 may include a drive source ECU which is a computer that controls a drive source (engine or motor) of the vehicle 10. In this case, when the key ID is successfully authenticated, the collation ECU 303 also transmits a command according to the command signal received from the key unit 100 to the drive source ECU. Accordingly, the drive source ECU can control the drive source of the vehicle 10.

The key unit 100 will be described. The key unit 100 is a device disposed at a predetermined position (for example, in a glove compartment) in the vehicle cabin of the vehicle 10. The key unit 100 has a function of authenticating the portable terminal 200 by performing short-range wireless communication with the portable terminal 200 and a function of transmitting a command signal to the control device 300 by using radio waves in the RF band based on the authentication result. The key unit 100 is configured to include an LF receiver 101, an RF transmitter 102, a short-range communication unit 103, and a controller 104.

The LF receiver 101 is a device that receives a polling signal transmitted from the control device 300 via radio waves in the LF band. The RF transmitter 102 is a device that transmits a command signal to the control device 300 via radio waves in the RF band. The short-range communication unit 103 is a device that communicates with the portable terminal 200 outside the vehicle 10. The short-range communication unit 103 performs communication at a short range (to the extent that communication between the inside of the vehicle cabin and the outside of the vehicle cabin can be performed) using a predetermined wireless communication standard. Examples of communication standards that can be used for communication by the short-range communication unit 103 can include Bluetooth (registered trademark) Low Energy standard, near field communication (NFC), ultra wide band (UWB), and Wi-Fi (registered trademark).

The controller 104 is a computer that performs processing of short-range wireless communication with the portable terminal 200, processing of authenticating the portable terminal 200, processing of transmitting a command signal to the control device 300, and the like. The controller 104 is constituted by, for example, a microcomputer.

The controller 104 has a function of controlling the LF receiver 101, the RF transmitter 102, and the short-range communication unit 103. The controller 104 authenticates the authentication information included in a control request transmitted from the portable terminal 200 through short-range wireless communication. Specifically, the controller 104 determines whether or not the authentication information transmitted from the portable terminal 200 matches the authentication information stored in advance in the storage unit of the controller 104. When the authentication is successful, the controller 104 transmits a command signal according to the control request received from the portable terminal 200 to the control device 300 via the RF transmitter 102. Specifically, when the control request received from the portable terminal 200 is a locking request, the controller 104 transmits the locking signal to the control device 300. In addition, when the control request received from the portable terminal 200 is an unlocking request, the controller 104 transmits the unlocking signal to the control device 300.

At this time, the key unit 100 transmits a key ID together with the command signal to the control device 300. The key ID may be stored in advance in the key unit 100 in a plain text state or may be stored in a state encrypted with a cryptogram unique to the portable terminal 200. In a case where the key ID is stored in the encrypted state, the encrypted key ID may be decrypted by the authentication information transmitted from the portable terminal 200 to obtain the original key ID.

The portable terminal 200 will be described. The portable terminal 200 is a compact computer such as a smartphone, a mobile phone, a tablet terminal, a personal information terminal, or a wearable computer (such as a smart watch). The portable terminal 200 is configured to include a short-range communication unit 201, a communication unit 202, a controller 203, and an input and output unit 204.

The short-range communication unit 201 is a device that communicates with the key unit 100 of the vehicle control device 11 according to the same communication standard as that of the short-range communication unit 103. The communication unit 202 is a device that connects the portable terminal 200 to a network in order to communicate with the center server 400. The communication unit 202 can communicate with the center server 400 via the network using, for example, a mobile communication service such as 3G or LTE. As will be described later, the communication unit 202 of the portable terminal 200 also communicates with a terminal management server that manages the portable terminal via the network.

The controller 203 is a computer that controls the portable terminal 200. The controller 203 is constituted by, for example, a microcomputer. The controller 203 performs processing of receiving the authentication information distributed from the center server 400 via the communication unit 202. The authentication information received from the center server 400 is stored in the storage unit of the controller 203. The controller 203 generates a control request according to an input manipulation of a terminal user who is a user carrying the portable terminal 200 and performs processing of transmitting the control request together with the authentication information stored in the storage unit to the key unit 100 via the short-range communication unit 201.

The input and output unit 204 also functions as means for receiving the input manipulation performed by the terminal user and presenting information to the terminal user. Specifically, the input and output unit 204 is configured to include a touch panel display and control means of the touch panel display. The input and output unit 204 may include a hardware switch or the like manipulated by the terminal user. The input and output unit 204 may include a speaker that outputs a sound or a voice under the control of the controller 203.

### Operation of Key System

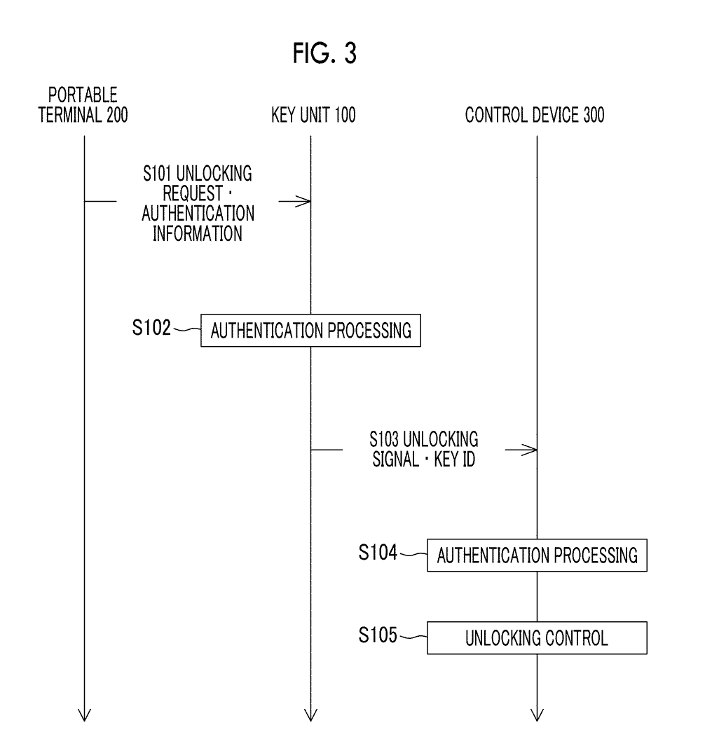

Here, the operation of the key system when the user controls the vehicle 10 using the portable terminal 200 will be described by taking a case of unlocking the door of the vehicle 10 as an example. FIG. 3 is a diagram illustrating processing and data flow when the door of the vehicle 10 is unlocked.

When the user performs a manipulation of unlocking the door of the vehicle 10 to the portable terminal 200, the portable terminal 200 transmits authentication information together with the unlocking request to the key unit 100 of the vehicle control device 11 (S101). Then, the key unit 100 performs authentication processing based on the authentication information received from the portable terminal 200 (S102). When the authentication information is successfully authenticated, the key unit 100 transmits the key ID together with the unlocking signal to the control device 300 (S103). Then, the control device 300 performs authentication processing based on the key ID received from the key unit 100 (S104). When the key ID is successfully authenticated, the control device 300 performs the unlocking control for unlocking the vehicle 10 (S105).

### Rescue System

A rescue system that rescues a person or an animal left behind in the vehicle cabin of the vehicle 10 equipped with such a key system will be described. When the vehicle 10 is locked in a state in which the person left behind in the vehicle cabin is a child or an animal is left behind, it is difficult for the child or the animal in the vehicle cabin to unlock the vehicle on their own and escape from the vehicle 10. The rescue system according to the embodiment is a system that allows another person around the vehicle 10, in a case where a situation arises in which the person or the animal left behind in the vehicle cabin of the vehicle 10 needs to be rescued, to rescue the person or the animal left behind in the vehicle cabin of the vehicle 10.

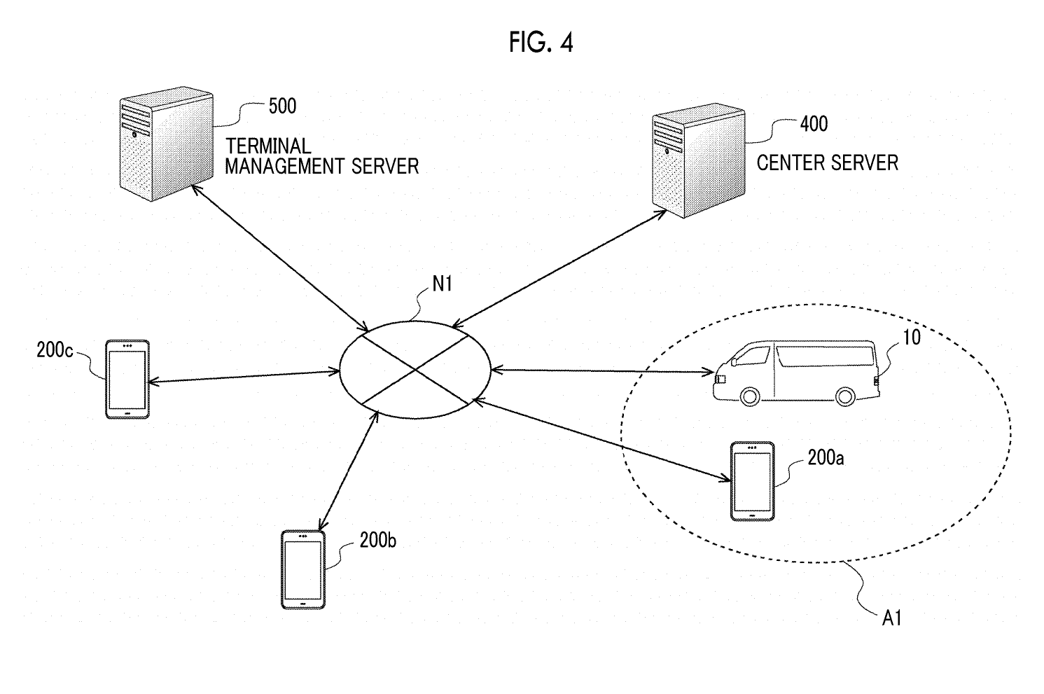

FIG. 4 is a diagram for describing a network to which the rescue system according to the embodiment is connected. As illustrated in FIG. 4, in the embodiment, the vehicle 10, the center server 400, a plurality of portable terminals 200a, 200b, 200c, and a terminal management server 500 are mutually connected via a network N1 such as the Internet which is a public communication network.

As described above, the center server 400 is a device that distributes the authentication information associated with the vehicle 10. The center server 400 manages the authentication information together with vehicle information for specifying the vehicle 10. The center server 400 acquires positional information of the vehicle 10 transmitted from the vehicle 10 and also manages the positional information together with the vehicle information. The terminal management server 500 acquires and manages the positional information of each terminal transmitted from the portable terminals 200a, 200b, 200c. The center server 400 and the terminal management server 500 can communicate with each other via a network N1.

### Component of Rescue System

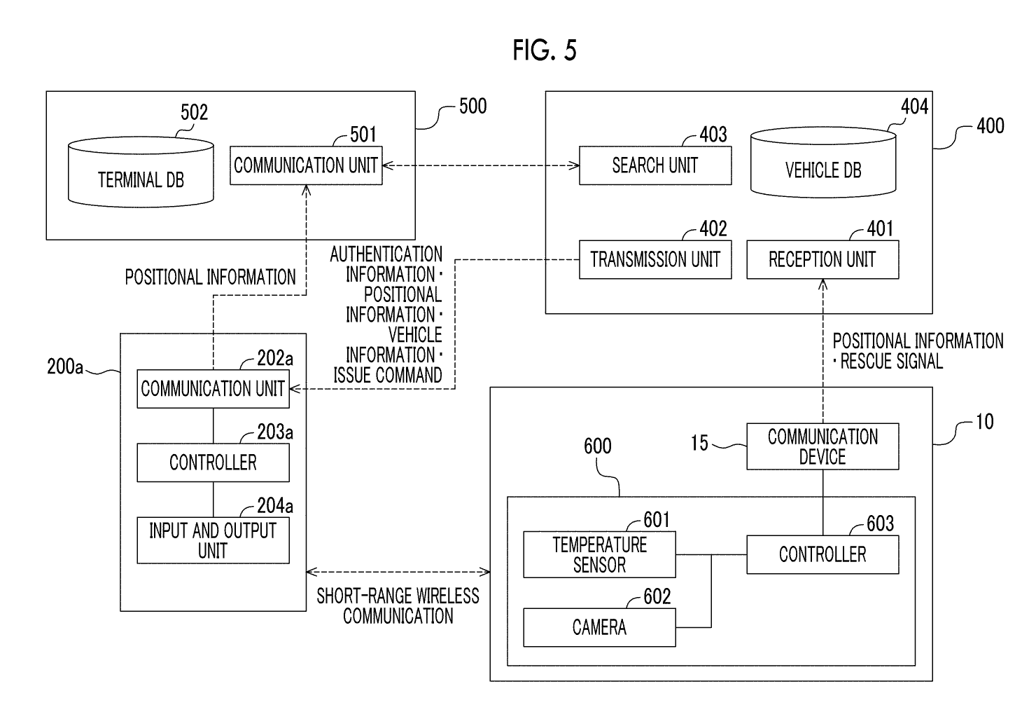

Each component in the rescue system according to the embodiment will be described with reference to FIG. 5. FIG. 5 is a block diagram schematically illustrating an example of the configuration of the vehicle 10, the center server 400, the portable terminal 200 (200a in FIG. 5), and the terminal management server 500 illustrated in FIG. 4. The vehicle 10 includes a communication device 15 and a detection device 600 in addition to the components illustrated in FIG. 2. The communication device 15 is a device that communicates with the center server 400 via the network N1. The detection device 600 is a device that detects the state in the vehicle cabin of the vehicle 10.

The detection device 600 is configured to include a temperature sensor 601, a camera 602, and a controller 603. The temperature sensor 601 is a sensor that detects a temperature in the vehicle cabin of the vehicle 10. The camera 602 is a camera that captures an image of the inside of the vehicle cabin of the vehicle 10. The controller 603 is a computer that controls the temperature sensor 601 and the camera 602. When the vehicle 10 is locked in a state in which the drive source of the vehicle 10 is stopped, the controller 603 activates the temperature sensor 601 and the camera 602. The controller 603 acquires a detection value of the temperature sensor 601 (that is, the temperature in the vehicle cabin) and information of the image captured by the camera 602 (that is, the image information in the vehicle cabin). The controller 603 executes detection processing based on the temperature in the vehicle cabin acquired from the temperature sensor 601 and the image information in the vehicle cabin acquired from the camera 602. The detection processing is processing of detecting a case where the state in the vehicle cabin has become a predetermined rescue needing state in which a person or an animal present in the vehicle cabin needs to be rescued.

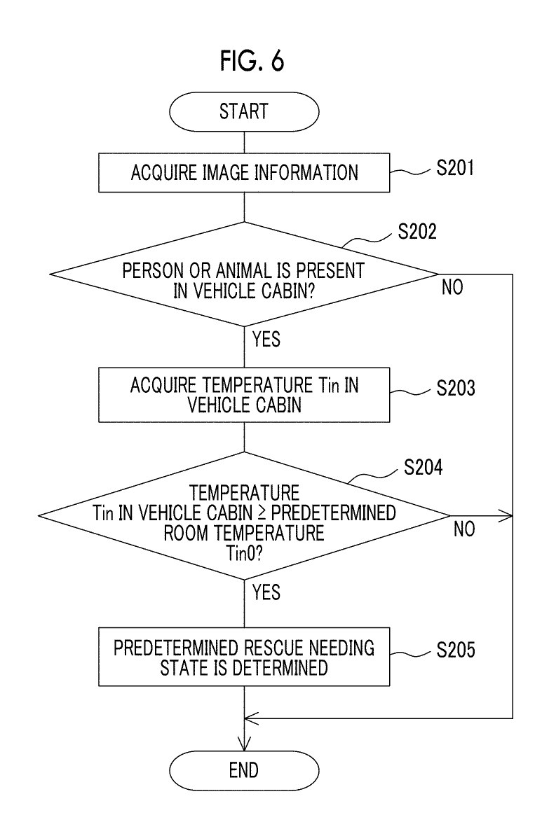

FIG. 6 is a flowchart illustrating flow of the detection processing executed by the controller 603 of the detection device 600. The controller 603 repeatedly executes the flow at a predetermined interval when the drive source of the vehicle 10 is stopped and the vehicle 10 is locked. In the flow, first, in S201, information of the image in the vehicle cabin captured by the camera 602 is acquired. Next, in S202, a determination is made whether or not a person or an animal is present in the vehicle cabin based on the image information acquired in S201. In a case where a negative determination is made in S202, that is, there is no person or animal to be rescued in the vehicle cabin, execution of the flow is temporarily ended.

Meanwhile, in a case where a positive determination is made in S202, next, a temperature Tin in the vehicle cabin detected by the temperature sensor 601 is acquired in S203. Next, a determination is made in S204 whether or not the temperature Tin in the vehicle cabin is equal to or higher than a predetermined room temperature Tin0. Here, the predetermined room temperature Tin0 is a temperature predetermined based on an experiment or the like as a temperature at which a health condition of the person or the animal present in the vehicle cabin may be impaired. In a case where a negative determination is made in S204, execution of the flow is temporarily ended. Meanwhile, in a case where the positive determination is made in S204, next, a determination is made in S205 that the state in the vehicle cabin is the predetermined rescue needing state. In other words, in the detection processing according to the embodiment, in a case where a person or an animal is present in the vehicle cabin and the temperature Tin in the vehicle cabin becomes equal to or higher than the predetermined room temperature Tin0, it is detected that the state in the vehicle cabin has become the predetermined rescue needing state.

The configuration and the detection processing of the detection device that detects whether or not the state in the vehicle cabin has become the predetermined rescue needing state are not limited to the above description. For example, a determination may be made whether or not a person or an animal that may be a rescue target is present in the vehicle cabin, based on a detection value of a seat sensor that detects a load applied to a seat of the vehicle. A determination may be made whether or not a state is the predetermined rescue needing state based on a facial expression of the person obtained by performing face recognition processing on the information of the image captured by the camera. Various sensors (such as a thermography camera) that detect an environment in the vehicle cabin or a physical condition of the person or the animal present in the vehicle cabin are installed in the vehicle, and a determination may be made whether or not a state is the predetermined rescue needing state, based on the detection value of the sensor.

When it is detected that the state in the vehicle cabin of the vehicle 10 is the predetermined rescue needing state by the detection processing executed by the controller 603 of the detection device 600, a rescue signal together with the positional information of the vehicle 10 is transmitted from the communication device 15 to the center server 400. The communication device 15 may transmit the positional information of the vehicle 10 to the center server 400 at a predetermined communication interval regardless of the detection processing by the controller 603. In the embodiment, the detection device 600 is an example of a “detection device” according to the aspects of the present disclosure. In the embodiment, the communication device 15 is an example of a “signal transmitter” according to the aspects of the present disclosure.

The configuration of the center server 400 will be described. The center server 400 is a computer having a microprocessor, and following functions are implemented by executing a program using the microprocessor. Some or all of the functions, however, may be implemented by hardware circuits such as ASIC or FPGA. The center server 400 is not necessarily implemented by one computer, and may be implemented by cooperation of a plurality of computers.

As illustrated in FIG. 5, the center server 400 includes a reception unit 401, a transmission unit 402, a search unit 403, and a vehicle database (vehicle DB) 404. The reception unit 401 receives the rescue signal transmitted from the communication device 15 of the vehicle 10 together with the positional information of the vehicle 10. Communication between the vehicle 10 and the center server 400 at this time is performed via the network N1 illustrated in FIG. 4.

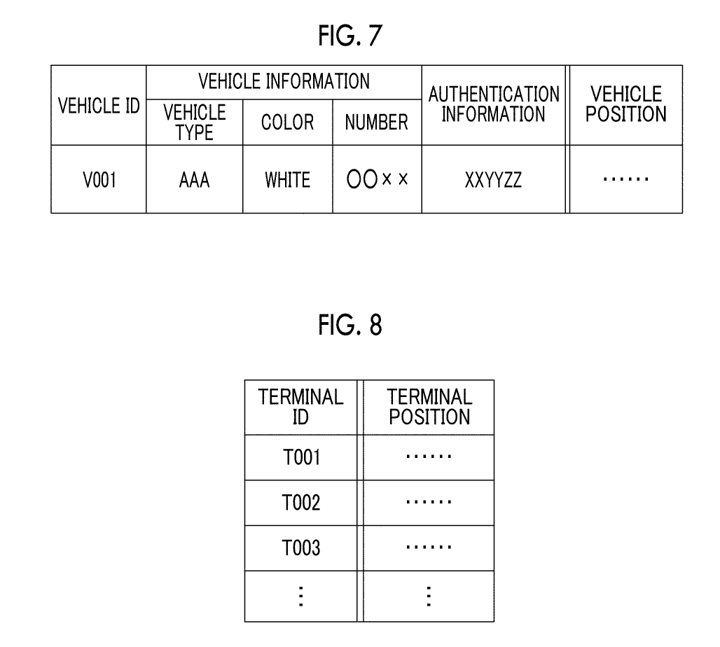

The vehicle DB 404 is a database that stores information related to each vehicle. Here, a table configuration of the information stored in the vehicle DB 404 will be described with reference to FIG. 7. FIG. 7 is a diagram illustrating an example a configuration of a vehicle management information table stored in the vehicle DB 404. The vehicle management information table has a vehicle ID field, a vehicle information field, an authentication information field, and a vehicle position field. A vehicle ID input in the vehicle ID field is an identification number associated with each vehicle. The vehicle information input in the vehicle information field is information for making it possible to specify the vehicle based on the information. The vehicle information field is constituted by a vehicle type field, a color field, and a number (vehicle registration number) field. The authentication information input in the authentication information field is authentication information used for the above-described key system. The positional information of the vehicle transmitted from each vehicle and received by the reception unit 401 is input to the vehicle position field.

Then, as described above, when the positional information of the vehicle 10 is transmitted together with the rescue signal from the communication device 15 of the vehicle 10, the positional information is input to the vehicle position field of the vehicle 10 in the vehicle DB 404. In the center server 400, when the reception unit 401 receives the rescue signal transmitted from the vehicle 10, the search unit 403 executes search processing. The search processing is processing of searching for a nearby terminal which is a portable terminal 200 present within a predetermined range from the position of the vehicle 10 that has transmitted the rescue signal (hereinafter also referred to simply as “nearby terminal”). Here, the predetermined range is set in advance as a range at which a person carrying the nearby terminal is considered to be able to go to rescue the person or the animal left behind in the vehicle cabin of the vehicle 10 which is a transmission source of the rescue signal. In FIG. 4, the predetermined range is indicated by a dashed line A1. Therefore, in FIG. 4, the portable terminal 200a among the portable terminals 200a, 200b, 200c is the nearby terminal.

Details of the search processing executed by the search unit 403 will be described. In a case where the search processing is executed, the search unit 403 communicates with the terminal management server 500. Communication between the center server 400 and the terminal management server 500 at this time is performed via the network N1 illustrated in FIG. 4.

The terminal management server 500 is a computer having a microprocessor, and following functions are implemented by executing a program using the microprocessor. Some or all of the functions, however, may be implemented by hardware circuits such as ASIC and FPGA. The terminal management server 500 is not necessarily implemented by one computer, and may be implemented by cooperation of a plurality of computers.

As illustrated in FIG. 5, the terminal management server 500 has a communication unit 501 and a terminal database (terminal DB) 502. The communication unit 501 communicates with the search unit 403 of the center server 400 via the network N1 as described above. The communication unit 501 also communicates with the portable terminals 200a, 200b, 200c via the network N1. Specifically, the communication unit 501 receives the positional information of each portable terminal 200 transmitted from the communication unit 202 of each portable terminal 200.

The terminal DB 502 is a database that stores information related to each portable terminal 200. Here, a table configuration of the information stored in the terminal DB 502 will be described with reference to FIG. 8. FIG. 8 is a diagram illustrating an example of the configuration of a terminal management information table stored in the terminal DB 502. The terminal management information table has a terminal ID field and a terminal position field. A terminal ID input in the terminal ID field is an identification number associated with each portable terminal 200. The positional information of each portable terminal 200 transmitted from each portable terminal 200 and received by the communication unit 501 is input to the terminal position field.

The search unit 403 of the center server 400 executes the search processing by accessing the terminal DB 502. In other words, the nearby terminal present within a predetermined range A1 from the position of the vehicle 10 is searched for based on the positional information of each portable terminal 200 stored in the terminal DB 502.

When the nearby terminal 200a is found, the search unit 403 extracts information (terminal ID) related to the nearby terminal 200a.

When the center server 400 finds the nearby terminal 200a by executing the search processing as described above, the transmission unit 402 transmits the positional information, the vehicle information, and the authentication information related to the vehicle 10 that has transmitted the rescue signal to the nearby terminal 200a. At this time, the transmission unit 402 transmits an issue command of an alarm signal to the nearby terminal 200a. Here, the alarm signal is a signal for prompting the terminal user to rescue the person or the animal present in the vehicle cabin of the vehicle 10.

When the positional information, the vehicle information, and the authentication information related to the vehicle 10, and the issue command of the alarm signal are transmitted from the transmission unit 402 of the center server 400, the above-described information and command are received by a communication unit 202a of the nearby terminal 200a. Communication between the center server 400 and the nearby terminal 200a at this time is performed via the network N1 illustrated in FIG. 4. In the nearby terminal 200a, when the communication unit 202a receives the above-described information and command, the positional information, the vehicle information, and the authentication information related to the vehicle 10 are stored in the storage unit of a controller 203a. Then, the controller 203a provides a notification of the positional information and the vehicle information of the vehicle 10 by controlling an input and output unit 204a. At this time, the controller 203a may display the information on a touch panel display of the input and output unit 204a. The controller 203a issues the alarm signal for prompting rescue of the person or the animal present in the vehicle cabin of the vehicle 10 by controlling the input and output unit 204a. At this time, in a case where the input and output unit 204a includes a speaker, the alarm signal may be issued as a predetermined sound or voice.

When the positional information and the vehicle information of the vehicle 10 are notified and the alarm signal is issued from the nearby terminal 200a, the terminal user carrying the nearby terminal 200a is prompted to go to the vehicle 10 that has transmitted the rescue signal for rescue. As the terminal user who goes to the vehicle 10 for rescue manipulates the nearby terminal 200a, when an unlocking request together with authentication information associated with the vehicle 10 is transmitted to the vehicle 10 through short-range wireless communication, the same processing as the operation of the key system illustrated in FIG. 3 is performed. As a result, the vehicle 10 is unlocked and it is possible to rescue the person or the animal left behind in the vehicle cabin.

In the center server 400 according to the embodiment, the reception unit 401 is an example of a “reception unit” according to the aspects of the present disclosure, the search unit 403 is an example of a “search unit” according to the aspects of the present disclosure, and the transmission unit 402 is an example of a “transmission unit” according to the aspects of the present disclosure. In the embodiment, the terminal management server 500 is an example of a “terminal information management device” according to the aspects of the present disclosure.

### Operation of Rescue system

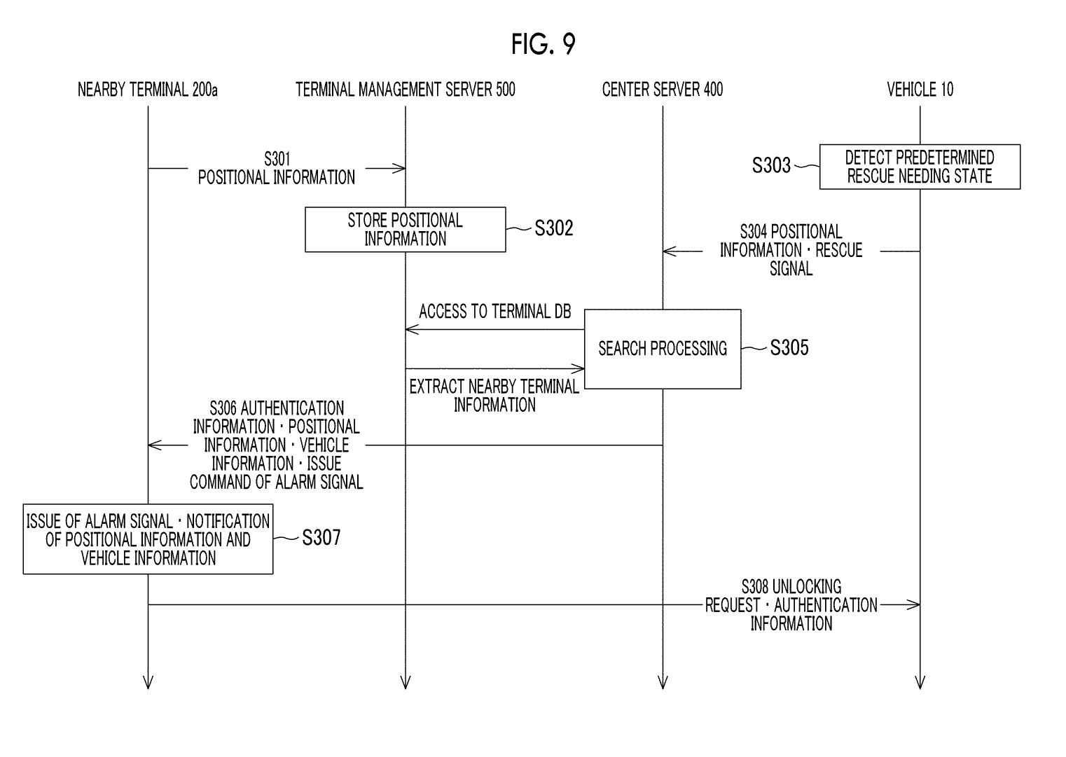

The operation of the rescue system according to the embodiment will be described with reference to FIG. 9. FIG. 9 is a diagram illustrating processing and data flow in a case where the vehicle 10 of which the state in the vehicle cabin has become the predetermined rescue needing state is unlocked using the nearby terminal 200a, by using the rescue system according to the embodiment.

In the embodiment, the positional information of each portable terminal 200 is transmitted from a plurality of the portable terminals 200 that may be the nearby terminal 200a to the terminal management server 500 (S301). Then, the positional information of each portable terminal 200 is stored in the terminal DB 502 of the terminal management server 500 (S302). Since the transmission of the positional information from each portable terminal 200 to the terminal management server 500 is repeatedly performed at a predetermined transmission interval, the positional information stored in the terminal management server 500 is also updated every time the information is received.

Meanwhile, when the detection processing illustrated in FIG. 6 is executed by the detection device 600 of the vehicle 10 and it is detected that the state in the vehicle cabin has become the predetermined rescue needing state (S303), the positional information of the vehicle 10 and the rescue signal are transmitted from the vehicle 10 to the center server 400 (S304). When the positional information of the vehicle 10 and the rescue signal are received, the center server 400 executes the search processing (S305). As described above, the search processing is performed by accessing the terminal DB 502 of the terminal management server 500. The information related to the nearby terminal 200a found in the terminal DB 502 is extracted.

When the nearby terminal 200a is found by executing the search processing, the center server 400 transmits the positional information, the vehicle information, and the authentication information related to the vehicle 10, and the issue command of the alarm signal to the nearby terminal 200a (S306). When the information and command are received, the nearby terminal 200a provides a notification of the positional information and vehicle information of the vehicle 10 and issues an alarm signal (S307). When the terminal user of the nearby terminal 200a prompted to rescue by the alarm signal manipulates the nearby terminal 200a to unlock the vehicle 10, the authentication information together with the unlocking request is transmitted from the nearby terminal 200a to the vehicle 10 (S308). As a result, the vehicle 10 is unlocked.

As described above, with the rescue system according to the embodiment, in a case where the state in the vehicle cabin of the vehicle 10 has become the predetermined rescue needing state, it is possible to prompt the terminal user carrying the nearby terminal 200a to go for rescue. When the nearby terminal 200a receives the authentication information associated with the vehicle 10, the terminal user can unlock the vehicle 10 using the nearby terminal 200a as a key to rescue the person or the animal left behind in the vehicle cabin. Therefore, another person around the vehicle 10 can rescue the person or the animal left behind in the vehicle cabin.

### First Modification Example

In the above embodiment, regarding the vehicle 10 which is an issue source of the rescue signal, not only the positional information of the vehicle 10 but also the vehicle information of the vehicle 10 are transmitted from the center server 400 to the nearby terminal 200a. Since the center server 400 has the vehicle DB 404 in which the vehicle management information table as illustrated in FIG. 7 is stored, the vehicle information of the vehicle 10 can be transmitted. There is, however, no need to necessarily transmit the vehicle information of the vehicle 10 to the nearby terminal 200a. In other words, even in a case where solely the positional information of the vehicle 10 is transmitted to the nearby terminal 200a and is notified from the nearby terminal 200a, it is possible to prompt the terminal user to go to the vehicle 10 for rescue. As in the above embodiment, however, by transmitting the vehicle information together with the positional information of the vehicle 10 to the nearby terminal 200a, the terminal user can more easily specify the vehicle 10 which is the issue source of the rescue signal.

### Second Modification Example

In the above embodiment, the search unit 403 of the center server 400 executes the search processing by accessing the terminal DB 502 of the terminal management server 500. The search method of the nearby terminal, however, is not limited to thereto. For example, the nearby terminal may be searched by issuing a search signal for searching for the nearby terminal from the vehicle 10 toward the surroundings.

What is claimed is:

1. A distribution device comprising a server device configured to distribute key information to a portable terminal, wherein:
the key information is used for a key system that determines whether or not to lock and unlock a vehicle when the vehicle receives the key information transmitted from the portable terminal to the vehicle;
the server device is configured to receive a rescue signal and positional information of the vehicle transmitted from the vehicle in a case where a state in a vehicle cabin of the vehicle is a predetermined rescue needing state in which a person or an animal present in the vehicle cabin needs to be rescued; and
the server device is configured to, when the server device receives the rescue signal,
search for a nearby terminal which is a portable terminal present within a predetermined range from a position of the vehicle based on the positional information of the vehicle, and
transmit the key information of the vehicle, the positional information of the vehicle, and an issue command of an alarm signal for prompting rescue of the person or the animal present in the vehicle cabin of the vehicle to the portable terminal searched for as the nearby terminal.

2. The distribution device according to claim 1, wherein:
the server device is configured to communicate with a terminal information management device that manages positional information of a plurality of portable terminals; and
the server device is configured to search for the nearby terminal based on the positional information of the vehicle and the positional information of the portable terminals in the terminal information management device.

3. The distribution device according to claim 1, wherein the server device is configured to transmit vehicle information for specifying the vehicle, together with the key information of the vehicle, the positional information of the vehicle, and the issue command, to the nearby terminal.

4. A rescue system comprising:
a portable terminal;
a vehicle equipped with a key system configured to perform locking and unlocking by receiving key information transmitted from the portable terminal, the vehicle including
a detection device configured to detect whether or not a state in a vehicle cabin of the vehicle has become a predetermined rescue needing state in which a person or an animal present in the vehicle cabin needs to be rescued, and
a signal transmitter configured to transmit positional information of the vehicle and transmit a rescue signal in a case where the detection device detects that the state in the vehicle cabin has become the predetermined rescue needing state; and
a server device configured to
receive the rescue signal and the positional information that are transmitted from the signal transmitter,
search for a nearby terminal which is a portable terminal present within a predetermined range from a position of the vehicle based on the positional information of the vehicle in a case where the rescue signal is received from the signal transmitter, and
transmit the key information of the vehicle, the positional information of the vehicle, and an issue command of an alarm signal for prompting rescue of the person or the animal present in the vehicle cabin of the vehicle, to the portable terminal searched for as the nearby terminal,
wherein the portable terminal is configured to provide a notification of the positional information of the vehicle and to issue the alarm signal when the portable terminal searched for as the nearby terminal receives the key information of the vehicle, the positional information of the vehicle, and the issue command of the alarm signal that are transmitted from the server device.

5. The rescue system according to claim 4, wherein when the portable terminal searched for as the nearby terminal receives the key information of the vehicle, the positional information of the vehicle, and the issue command of the alarm signal that are transmitted from the server device, the portable terminal provides the notification of the positional information of the vehicle, issues the alarm signal, and transmits the key information and an unlocking request to the vehicle according to a manipulation of a person carrying the portable terminal.

6. A method of controlling a distribution device including a server device configured to distribute key information to a portable terminal, the key information being used for a key system that determines whether or not to lock and unlock a vehicle when the vehicle receives the key information transmitted from the portable terminal to the vehicle, the method comprising:
receiving a rescue signal and positional information of the vehicle transmitted from the vehicle when a state in a vehicle cabin of the vehicle becomes a predetermined rescue needing state in which a person or an animal present in the vehicle cabin needs to be rescued, using the server device; and
searching for a nearby terminal which is a portable terminal present within a predetermined range from a position of the vehicle based on the positional information of the vehicle, and transmitting the key information of the vehicle, the positional information of the vehicle, and an issue command of an alarm signal for prompting rescue of the person or the animal present in the vehicle cabin of the vehicle to the nearby terminal, using the server device.

7. A non-transitory computer-readable recording medium storing a program causing a computer to execute a method of controlling a distribution device including a server device configured to distribute key information to a portable terminal, the key information being used for a key system that determines whether or not to lock and unlock a vehicle when the vehicle receives the key information transmitted from the portable terminal to the vehicle, the program causing a control process of the distribution device to be executed, the control process comprising:
receiving a rescue signal and positional information of the vehicle transmitted from the vehicle when a state in a vehicle cabin of the vehicle becomes a predetermined rescue needing state in which a person or an animal present in the vehicle cabin needs to be rescued, using the server device; and
searching for a nearby terminal which is a portable terminal present within a predetermined range from a position of the vehicle based on the positional information of the vehicle, and transmitting the key information of the vehicle, the positional information of the vehicle, and an issue command of an alarm signal for prompting rescue of the person or the animal present in the vehicle cabin of the vehicle to the nearby terminal, using the server device.
